(19) United States
(12) Patent Application Publication
(10) Pub. No.: US 2023/0344245 A1
(43) Pub. Date: Oct. 26, 2023

(54) BYPASS CIRCUIT AND ELECTRICAL STORAGE SYSTEM

(71) Applicant: YAZAKI CORPORATION, Tokyo (JP)

(72) Inventor: Takahiro Syouda, Susono-shi (JP)

(21) Appl. No.: 18/298,319

(22) Filed: Apr. 10, 2023

(30) Foreign Application Priority Data
Apr. 26, 2022 (JP) 2022-072113
Oct. 11, 2022 (JP) 2022-162956

(51) Int. Cl. H02J 7/00

(52) U.S. Cl. CPC H02J 7/0016; H02J 7/0031

(57) ABSTRACT

There are provided a bypass circuit and an electrical storage system, the bypass circuit being provided in an electrical storage system including a plurality of electrical storage batteries connected in series and bypasses the electrical storage batteries. The bypass circuit includes: a first switch provided between the adjacent electrical storage batteries, the first switch being opened and closed in response to a first control signal output from a control circuit; a bypass line that bypasses the first switch and each of the electrical storage batteries; a second switch provided on the bypass line, the second switch being opened and closed in response to a second control signal output from the control circuit; and a co-closing prevention unit configured to prevent the first switch and the second switch from being in a closed state at the same time.

### CROSS-REFERENCE TO RELATED APPLICATIONS

This application is based on and claims priority under 35 USC 119 from Japanese Patent Application No. 2022-072113 filed on Apr. 26, 2022, and Japanese Patent Application No. 2022-162956 filed on Oct. 11, 2022, the contents of which are incorporated herein by reference.

### TECHNICAL FIELD

The present disclosure relates to a bypass circuit and an electrical storage system.

### BACKGROUND ART

As a system that controls discharge of an electrical storage system including a plurality of electrical storage batteries connected in series, a system is known in which an electrical storage battery that cannot discharge at a required current is bypassed and the current is discharged from another electrical storage battery (for example, see JP2013-031247A). As a system that controls charge of an electrical storage system including a plurality of electrical storage batteries connected in series, a system is known in which an electrical storage battery that cannot be charged by a received current is bypassed to charge another electrical storage battery (for example, see JP2013-031249A). The electrical storage systems described in JP2013-031247A and JP2013-031249A each include a first switch that connects or disconnects electrical storage batteries, and a second switch that connects or disconnects bypass lines.

In the electrical storage systems described in JP2013-031247A and JP2013-031249A, from a viewpoint of preventing a short circuit, it is necessary to comply with an operation order and an operation interval between the first switch and the second switch in operation of bypassing an electrical storage battery or operation of releasing a bypass state of an electrical storage battery. Specifically, in the operation of bypassing the electrical storage battery, a control unit needs to output a control signal for bringing the second switch into a connected state after outputting a control signal for bringing the first switch into a disconnected state and waiting for sufficient time for the first switch to switch to the disconnected state. In the operation of releasing the bypass state of the electrical storage battery, the control unit needs to output a control signal for bringing the first switch into a connected state after outputting a control signal for bringing the second switch into a disconnected state and waiting for sufficient time for the second switch to switch to the disconnected state. However, the operation order and the operation interval between the first switch and the second switch may be not complied with due to a malfunction of the control unit.

### SUMMARY OF INVENTION

The present disclosure provides a bypass circuit and an electrical storage system that can reliably prevent a short circuit during operation of the bypass circuit in an electrical storage system including a plurality of electrical storage batteries connected in series and a bypass circuit that bypasses the electrical storage battery.

According to an aspect of the present disclosure, a bypass circuit is provided in an electrical storage system including a plurality of electrical storage batteries connected in series and bypasses the electrical storage batteries. The bypass circuit includes: a first switch provided between the adjacent electrical storage batteries, the first switch being opened and closed in response to a first control signal output from a control circuit; a bypass line that bypasses the first switch and each of the electrical storage batteries; a second switch provided on the bypass line, the second switch being opened and closed in response to a second control signal output from the control circuit; and a co-closing prevention unit configured to prevent the first switch and the second switch from being in a closed state at the same time.

According to another aspect of the present disclosure, an electrical storage system includes: a plurality of electrical storage batteries connected in series; and a bypass circuit configured to bypass the electrical storage batteries. The bypass circuit includes: a first switch provided between the adjacent electrical storage batteries, the first switch being opened and closed in response to a first control signal output from a control circuit; a bypass line configured to bypass the first switch and each of the electrical storage batteries; a second switch provided on the bypass line, the second switch being opened and closed in response to a second control signal output from the control circuit; and a co-closing prevention unit configured to prevent the first switch and the second switch from being in a closed state at the same time.

According to the present disclosure, a short circuit during operation of a bypass circuit can be reliably prevented in an electrical storage system including a plurality of electrical storage batteries connected in series and a bypass circuit that bypasses the electrical storage battery.

### BRIEF DESCRIPTION OF DRAWINGS

FIG. 1 is a circuit diagram schematically showing an electrical storage system including a bypass circuit according to an embodiment of the present disclosure;

FIG. 2 is a circuit diagram schematically showing an electrical storage system including a bypass circuit according to another embodiment of the present disclosure;

FIG. 3 is a circuit diagram schematically showing an electrical storage system including a bypass circuit according to another embodiment of the present disclosure;

FIG. 4 is a circuit diagram schematically showing an electrical storage system including a bypass circuit according to another embodiment of the present disclosure;

FIG. 5 is a circuit diagram schematically showing an electrical storage system including a bypass circuit according to another embodiment of the present disclosure;

FIG. 6 is a circuit diagram schematically showing an electrical storage system including a bypass circuit according to another embodiment of the present disclosure;

FIG. 7 is a circuit diagram schematically showing an electrical storage system including a bypass circuit according to another embodiment of the present disclosure; and

FIG. 8 is a circuit diagram schematically showing an electrical storage system including a bypass circuit according to another embodiment of the present disclosure.

### DESCRIPTION OF EMBODIMENTS

Hereinafter, the present disclosure will be described in accordance with preferred embodiments. The present disclosure is not limited to the following embodiments, and the embodiments can be appropriately changed without departing from the gist of the present disclosure. In the following embodiments, a part of configurations may be not described or shown in the drawings, and regarding details of the omitted techniques, publicly known or well-known techniques are appropriately applied as long as there is no contradiction with contents described below.

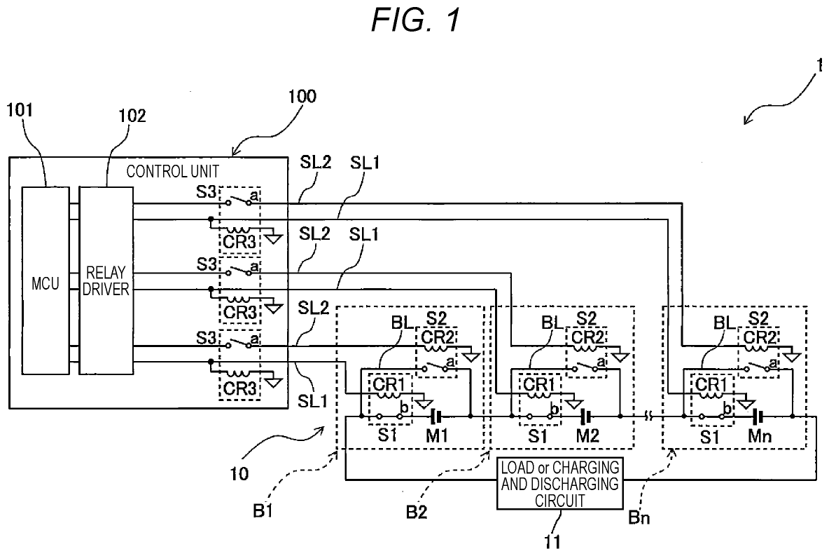

FIG. 1 is a circuit diagram schematically showing an electrical storage system 1 including bypass circuits B1 to Bn according to an embodiment of the present disclosure. The electrical storage system 1 shown in FIG. 1 is a stationary or in-vehicle power supply, and includes an electrical storage battery string 10 and a control unit 100. The electrical storage battery string 10 is connected to a load or charging and discharging circuit 11.

The electrical storage battery string 10 includes n (n is an integer equal to or greater than 2) electrical storage battery modules M1 to Mn connected in series. Although not particularly limited, the electrical storage battery string 10 according to the present embodiment is recycled used electrical storage batteries, and the electrical storage battery modules M1 to Mn differ in a degree of deterioration. The electrical storage battery modules M1 to Mn are secondary batteries such as lithium ion batteries and lithium ion capacitors.

A positive electrode of the electrical storage battery module M1 as the beginning and a negative electrode of the electrical storage battery module Mn as the end are connected to the load or charging and discharging circuit 11. The electrical storage battery modules M1 to Mn are charged by being supplied with electrical power from the load or charging and discharging circuit 11, and discharge the charged electrical power to supply electrical power to the load or charging and discharging circuit 11.

The load or charging and discharging circuit 11 includes a load, a generator, a power converter and the like. In a case where the electrical storage system 1 is stationary, the load includes a household electrical appliance, a commercial power supply system, a liquid crystal display, a communication module and the like, and the generator includes a photovoltaic power generation system and the like. On the other hand, in a case where the electrical storage system 1 is used for a vehicle, the load includes a driving motor, an air conditioner, various in-vehicle electrical devices and the like. The driving motor serves as the load and the generator.

The electrical storage battery string 10 may include n electrical storage battery cells or electrical storage battery packs connected in series instead of the n electrical storage battery modules M1 to Mn connected in series. The electrical storage system 1 may include a bypass circuit that bypasses the electrical storage battery cells or the electrical storage battery packs.

The electrical storage system 1 includes n bypass circuits B1 to Bn. The bypass circuits B1 to Bn are provided respectively for the electrical storage battery modules M1 to Mn. The bypass circuits B1 to Bn each include a bypass line BL, a disconnect signal line SL1, a bypass signal line SL2, a disconnect switch S1, a bypass switch S2, and a safety switch S3.

The disconnect switch S1 is provided between a positive electrode of each of the electrical storage battery modules M1 to Mn and one end of the bypass line BL. Examples of the disconnect switch S1 include a relay and a semiconductor switch. The disconnect switch S1 according to the present embodiment is a relay, and includes a b-contact and a coil CR1.

The b-contact of the disconnect switch S1 is provided on an electrical power line connecting adjacent electrical storage battery modules M1 to Mn. The coil CR1 of the disconnect switch S1 is provided in the disconnect signal line SL1. When a signal current is output from a relay driver 102 of the control unit 100 to the coil CR1 of the disconnect switch S1 through the disconnect signal line SL1, the b-contact of the disconnect switch S1 is opened, and a corresponding one of the electrical storage battery modules M1 to Mn is in a disconnected state.

The bypass line BL is an electrical power line that bypasses a corresponding one of the electrical storage battery modules M1 to Mn and the disconnect switch S1. The bypass switch S2 is provided on the bypass line BL. Examples of the bypass switch S2 include a relay and a semiconductor switch. The bypass switch S2 according to the present embodiment is a relay, and includes an a-contact and a coil CR2.

The a-contact of the bypass switch S2 is provided on the bypass line BL, and the coil CR2 of the bypass switch S2 is provided in the bypass signal line SL2. When a signal current is output from the relay driver 102 of the control unit 100 to the coil CR2 of the bypass switch S2 through the bypass signal line SL2, the a-contact of the bypass switch S2 is closed and the bypass line BL is in a connected state.

When the disconnect switch S1 is in a connected state and the bypass switch S2 is in a disconnected state in all the bypass circuits B1 to Bn, all the electrical storage battery modules M1 to Mn are connected in series to the load or charging and discharging circuit 11. On the other hand, when the disconnect switch S1 is in a disconnected state and the bypass switch S2 is in a connected state in one of the bypass circuits B1 to Bn, one of the electrical storage battery modules M1 to Mn that corresponds to the one of the bypass circuits B1 to Bn is bypassed.

The control unit 100 includes a micro-controller unit (MCU) 101, the relay driver 102, and n safety switches S3. The MCU 101 executes monitoring and control of the electrical storage battery modules M1 to Mn, switching control of the bypass circuits B1 to Bn and the like. The relay driver 102 outputs a signal current for energizing the coil CR1 of the disconnect switch S1 to the disconnect signal line SL1 in accordance with a command from the MCU 101. The relay driver 102 also outputs a signal current for energizing the coil CR2 of the bypass switch S2 to the bypass signal line SL2.

The safety switches S3 are provided respectively for the electrical storage battery modules M1 to Mn. Examples of the safety switch S3 include a relay and a semiconductor switch. The safety switch S3 according to the present embodiment is a relay, and includes an a-contact and a coil CR3.

The a-contact of the safety switch S3 is provided on the bypass signal line SL2, and the coil CR3 of the safety switch S3 is connected to the disconnect signal line SL1. When the relay driver 102 outputs a signal current to the coil CR1 of the disconnect switch S1 through the disconnect signal line SL1, the signal current is also output to the coil CR3 of the safety switch S3. When the signal current is output from the relay driver 102 to the coil CR3 of the safety switch S3, the a-contact of the safety switch S3 is closed, the bypass signal line SL2 is in a connected state, and the signal current can be output from the relay driver 102 to the coil CR2 of the bypass switch S2. On the other hand, when no signal current is output from the relay driver 102 to the coil CR1 of the disconnect switch S1, no signal current is output to the coil CR3 of the safety switch S3, and no signal current can be output from the relay driver 102 to the coil CR2 of the bypass switch S2.

That is, during a period in which no signal current is output from the relay driver 102 to the coil CR1 of the disconnect switch S1, the bypass signal line SL2 is disconnected by the safety switch S3, and a state in which no signal current can be output from the relay driver 102 to the coil CR2 of the bypass switch S2 is maintained. During a period in which a signal current is output from the relay driver 102 to the coil CR1 of the disconnect switch S1, the bypass signal line SL2 is connected by the safety switch S3, and a state in which the signal current can be output from the relay driver 102 to the coil CR2 of the bypass switch S2 is maintained.

When the electrical storage battery modules M1 to Mn are bypassed by the bypass circuits B1 to Bn, the relay driver 102 first outputs a signal current to the coil CR1 of the disconnect switch S1, and then outputs a signal current to the coil CR2 of the bypass switch S2. That is, the relay driver 102 first switches the disconnect switch S1 to the disconnected state, and then switches the bypass switch S2 to the connected state. Accordingly, the electrical storage battery modules M1 to Mn are prevented from being short-circuited through the bypass line BL during the bypass operation.

Here, a situation in which a timing of outputting the signal current for switching the disconnect switch S1 to the disconnected state (hereinafter, may be referred to as a disconnect signal) and a timing of outputting the signal current for switching the bypass switch S2 to the connected state (hereinafter, may be referred to as a bypass signal) are reversed due to erroneous operation of the MCU 101 will be studied. In such a situation, the relay driver 102 attempts to output the bypass signal before outputting the disconnect signal in accordance with a command from the MCU 101. However, at the timing of outputting the bypass signal, the bypass signal is not output to the coil CR2 of the bypass switch S2 since the bypass signal line SL2 is disconnected by the safety switch S3. Therefore, even when erroneous operation of the MCU 101 occurs, the a-contact of the bypass switch S2 will not be closed in a state where the b-contact of the disconnect switch S1 is closed, and the electrical storage battery modules M1 to Mn are reliably prevented from being short-circuited through the bypass line BL.

On the other hand, during bypass release operation in which the electrical storage battery modules M1 to Mn are released from bypass states by the bypass circuits B1 to Bn, the relay driver 102 first stops outputting a signal current to the coil CR2 of the bypass switch S2, and then stops outputting a signal current to the coil CR1 of the disconnect switch S1. That is, the relay driver 102 first switches the bypass switch S2 to the disconnected state, and then switches the disconnect switch S1 to the connected state. Accordingly, the electrical storage battery modules M1 to Mn are prevented from being short-circuited through the bypass line BL during the bypass release operation.

Here, a situation in which a timing of stopping outputting the bypass signal and a timing of stopping outputting the disconnect signal are reversed due to erroneous operation of the MCU 101 will be studied. In such a situation, the relay driver 102 attempts to stop outputting the disconnect signal before stopping outputting the bypass signal in accordance with a command from the MCU 101. In this case, since the output of the disconnect signal stops, output of the signal current to the coil CR3 of the safety switch S3 stops, and output of the bypass signal also stops. Therefore, even when erroneous operation of the MCU 101 occurs, the b-contact of the disconnect switch S1 will not be closed in a state where the a-contact of the bypass switch S2 is closed, and the electrical storage battery modules M1 to Mn are reliably prevented from being short-circuited through the bypass line BL.

Here, since the safety switch S3 is provided not in the electrical storage battery string 10 but in the control unit 100, wiring in the electrical storage battery string 10 can be simplified.

The b-contact of the disconnect switch S1 may be replaced with an a-contact, the a-contact of the bypass switch S2 may be replaced with a b-contact, and the a-contact of the safety switch S3 may be replaced with a b-contact. In this case, when a corresponding one of the electrical storage battery modules M1 to Mn is connected, a signal current may be output to the coil CR1 of the disconnect switch S1, the coil CR2 of the bypass switch S2, and the coil CR3 of the safety switch S3. When a corresponding one of the electrical storage battery modules M1 to Mn is bypassed, no signal current may be output to the coil CR1 of the disconnect switch S1, the coil CR2 of the bypass switch S2, and the coil CR3 of the safety switch S3.

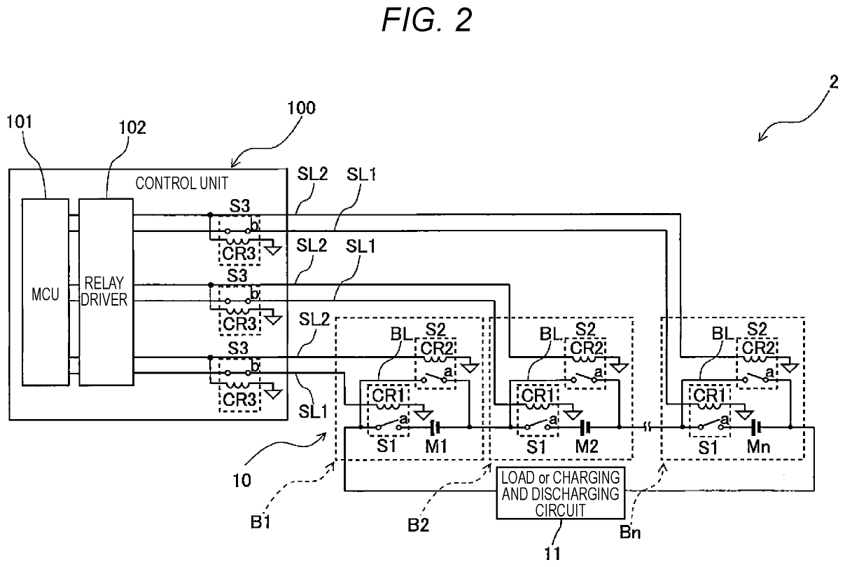

FIG. 2 is a circuit diagram schematically showing an electrical storage system 2 including the bypass circuits B1 to Bn according to another embodiment of the present disclosure. The electrical storage system 2 according to the present embodiment is different from the electrical storage system 1 according to the above-described embodiment in configurations of the bypass circuits B1 to Bn, and particularly configurations of the disconnect switch S1 and the safety switch S3.

The bypass circuits B1 to Bn according to the present embodiment each include the bypass line BL, the disconnect signal line SL1, the bypass signal line SL2, the disconnect switch S1, the bypass switch S2, and the safety switch S3. Configurations of the bypass line BL and the bypass switch S2 are the same as those of the electrical storage system 1 according to the above-described embodiment.

n disconnect switches S1 are provided respectively for the electrical storage battery modules M1 to Mn. Examples of the disconnect switch S1 include a relay and a semiconductor switch. The disconnect switch S1 according to the present embodiment is a relay, and includes an a-contact and the coil CR1.

The a-contact of the disconnect switch S1 is provided on an electrical power line of the electrical storage battery string 10, and the coil CR1 of the disconnect switch S1 is provided in the disconnect signal line SL1. When a signal current is output from the relay driver 102 to the coil CR1 of the disconnect switch S1 through the disconnect signal line SL1, the a-contact of the disconnect switch S1 is closed, and a corresponding one of the electrical storage battery modules M1 to Mn is in a connected state.

n safety switches S3 are provided respectively for the electrical storage battery modules M1 to Mn in the control unit 100. Examples of the safety switch S3 include a relay and a semiconductor switch. The safety switch S3 according to the present embodiment is a relay, and includes a b-contact and the coil CR3.

The b-contact of the safety switch S3 is provided on the disconnect signal line SL1, and the coil CR3 of the safety switch S3 is connected to the bypass signal line SL2. When the relay driver 102 outputs a signal current to the coil CR2 of the bypass switch S2 through the bypass signal line SL2, the signal current is also output to the coil CR3 of the safety switch S3. When the signal current is output from the relay driver 102 to the coil CR3 of the safety switch S3, the b-contact of the safety switch S3 is opened, the disconnect signal line SL1 is in a disconnected state, and the signal current cannot be output to from the relay driver 102 to the coil CR1 of the disconnect switch S1. On the other hand, when no signal current is output from the relay driver 102 to the coil CR2 of the bypass switch S2, no signal current is output to the coil CR3 of the safety switch S3, the b-contact of the safety switch S3 is closed, the disconnect signal line SL1 is in a connected state, and a signal current can be output from the relay driver 102 to the coil CR1 of the disconnect switch S1.

That is, during a period in which a signal current is output from the relay driver 102 to the coil CR2 of the bypass switch S2, the disconnect signal line SL1 is disconnected by the safety switch S3, and a state in which the signal current cannot be output from the relay driver 102 to the coil CR1 of the disconnect switch S1 is maintained. In a period in which no signal current is output from the relay driver 102 to the coil CR2 of the bypass switch S2, the disconnect signal line SL1 is connected by the safety switch S3, and a state in which the signal current can be output from the relay driver 102 to the coil CR1 of the disconnect switch S1 is maintained.

During bypass operation by the bypass circuits B1 to Bn, the relay driver 102 first stops outputting a signal current to the coil CR1 of the disconnect switch S1, and then outputs a signal current to the coil CR2 of the bypass switch S2. That is, the relay driver 102 first switches the disconnect switch S1 to the disconnected state, and then switches the bypass switch S2 to the connected state. Accordingly, the electrical storage battery modules M1 to Mn are prevented from being short-circuited through the bypass line BL during the bypass operation.

Here, a situation in which a timing of stopping outputting the disconnect signal and a timing of starting outputting the bypass signal are reversed due to erroneous operation of the MCU 101 will be studied. In such a situation, the relay driver 102 attempts to start outputting the bypass signal before stopping outputting the disconnect signal in accordance with a command from the MCU 101. However, at the timing of starting outputting the bypass signal, the output of the disconnect signal stops since the disconnect signal line SL1 is disconnected by the safety switch S3. Therefore, even when erroneous operation of the MCU 101 occurs, the a-contact of the bypass switch S2 will not be closed in a state where the a-contact of the disconnect switch S1 is closed, and the electrical storage battery modules M1 to Mn are reliably prevented from being short-circuited through the bypass line BL.

On the other hand, during bypass release operation by the bypass circuits B1 to Bn, the relay driver 102 first stops outputting a signal current to the coil CR2 of the bypass switch S2, and then starts outputting a signal current to the coil CR1 of the disconnect switch S1. That is, the relay driver 102 first switches the bypass switch S2 to the disconnected state, and then switches the disconnect switch S1 to the connected state. Accordingly, the electrical storage battery modules M1 to Mn are prevented from being short-circuited through the bypass line BL during the bypass release operation.

Here, a situation in which a timing of stopping outputting the bypass signal and a timing of starting outputting the disconnect signal are reversed due to erroneous operation of the MCU 101 will be studied. In such a situation, the relay driver 102 attempts to start outputting the disconnect signal before stopping outputting the bypass signal in accordance with a command from the MCU 101. In this case, since the output of the bypass signal stops, output of the signal current to the coil CR3 of the safety switch S3 stops, and no signal current can be output from the relay driver 102 to the coil CR1 of the disconnect switch S1. Therefore, even when erroneous operation of the MCU 101 occurs, the a-contact of the disconnect switch S1 will not be closed in a state where the a-contact of the bypass switch S2 is closed, and the electrical storage battery modules M1 to Mn are reliably prevented from being short-circuited through the bypass line BL.

Here, since the safety switch S3 is provided not in the electrical storage battery string 10 but in the control unit 100, wiring in the electrical storage battery string 10 can be simplified.

The a-contact of the disconnect switch S1 may be replaced with a b-contact, the a-contact of the bypass switch S2 may be replaced with a b-contact, and the b-contact of the safety switch S3 may be replaced with an a-contact. In this case, when a corresponding one of the electrical storage battery modules M1 to Mn is connected, no signal current may be output to the coil CR1 of the disconnect switch S1, and a signal current may be output to the coil CR2 of the bypass switch S2 and the coil CR3 of the safety switch S3. When a corresponding one of the electrical storage battery modules M1 to Mn is bypassed, a signal current may be output to the coil CR1 of the disconnect switch S1, and no signal current may be output to the coil CR2 of the bypass switch S2 and the coil CR3 of the safety switch S3.

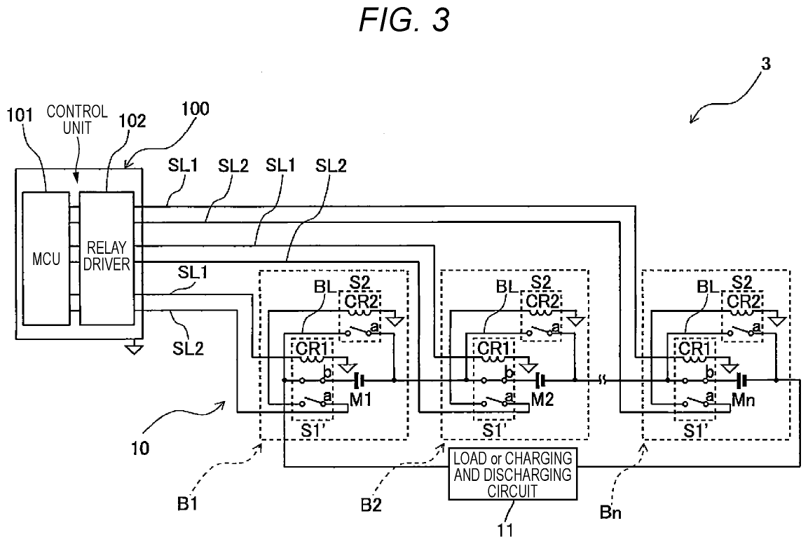

FIG. 3 is a circuit diagram schematically showing an electrical storage system 3 including the bypass circuits B1 to Bn according to another embodiment of the present disclosure. The electrical storage system 3 according to the present embodiment is different from the electrical storage system 1 according to the above-described embodiment in configurations of the bypass circuits B1 to Bn. In particular, the electrical storage system 3 according to the present embodiment is different from the electrical storage system 1 according to the above-described embodiment in that the electrical storage system 3 includes a disconnect switch S1′ having functions of the disconnect switch S1 and the safety switch S3 and the electrical storage system 1 includes the disconnect switch S1 and the safety switch S3.

The bypass circuits B1 to Bn according to the present embodiment each include the bypass line BL, the disconnect signal line SL1, the bypass signal line SL2, the disconnect switch S1′, and the bypass switch S2. Configurations of the bypass line BL and the bypass switch S2 are the same as those of the electrical storage system 1 according to the above-described embodiment.

n disconnect switches S1′ are provided respectively for the electrical storage battery modules M1 to Mn. Examples of the disconnect switch S1′ include a relay and a semiconductor switch. The disconnect switch S1′ according to the present embodiment is a relay, and includes an a-contact, a b-contact, and the coil CR1.

The b-contact of the disconnect switch S1′ is provided on an electrical power line of the electrical storage battery string 10, and the a-contact of the disconnect switch S1′ is provided on the bypass signal line SL2. The coil CR1 of the disconnect switch S1′ is provided in the disconnect signal line SL1. When the relay driver 102 outputs a signal current to the coil CR1 of the disconnect switch S1′ through the disconnect signal line SL1, the a-contact of the disconnect switch S1′ is closed, the bypass signal line SL2 is in a connected state, and the signal current can be output from the relay driver 102 to the coil CR2 of the bypass switch S2. On the other hand, when no signal current is output from the relay driver 102 to the coil CR1 of the disconnect switch S1′, the a-contact of the disconnect switch S1′ is in an opened state, and no signal current can be output from the relay driver 102 to the coil CR2 of the bypass switch S2.

That is, during a period in which no signal current is output from the relay driver 102 to the coil CR1 of the disconnect switch S1′, the bypass signal line SL2 is disconnected by the a-contact of the disconnect switch S1′, and a state in which no signal current can be output from the relay driver 102 to the coil CR2 of the bypass switch S2 is maintained. During a period in which a signal current is output from the relay driver 102 to the coil CR1 of the disconnect switch S1′, the bypass signal line SL2 is connected by the a-contact of the disconnect switch S1′, and a state in which the signal current can be output from the relay driver 102 to the coil CR2 of the bypass switch S2 is maintained.

During bypass operation by the bypass circuits B1 to Bn, the relay driver 102 first outputs a signal current to the coil CR1 of the disconnect switch S1′, and then outputs a signal current to the coil CR2 of the bypass switch S2. That is, the relay driver 102 first switches the b-contact of the disconnect switch S1′ to a disconnected state, and then switches the bypass switch S2 to a connected state. Accordingly, the electrical storage battery modules M1 to Mn are prevented from being short-circuited through the bypass line BL during the bypass operation.

Here, a situation in which a timing of outputting the disconnect signal and a timing of outputting the bypass signal are reversed due to erroneous operation of the MCU 101 will be studied. In such a situation, the relay driver 102 attempts to start outputting the bypass signal before starting outputting the disconnect signal in accordance with a command from the MCU 101. However, at the timing of starting outputting the bypass signal, no signal current is output from the relay driver 102 to the coil CR2 of the bypass switch S2 since the bypass signal line SL2 is disconnected by the a-contact of the disconnect switch S1′. Therefore, even when erroneous operation of the MCU 101 occurs, the a-contact of the bypass switch S2 will not be closed in a state where the b-contact of the disconnect switch S1′ is closed, and the electrical storage battery modules M1 to Mn are reliably prevented from being short-circuited through the bypass line BL.

On the other hand, during bypass release operation by the bypass circuits B1 to Bn, the relay driver 102 first stops outputting a signal current to the coil CR2 of the bypass switch S2, and then stops outputting a signal current to the coil CR1 of the disconnect switch S1′. That is, the relay driver 102 first switches the bypass switch S2 to the disconnected state, and then switches the b-contact of the disconnect switch S1′ to the connected state. Accordingly, the electrical storage battery modules M1 to Mn are prevented from being short-circuited through the bypass line BL during the bypass release operation.

Here, a situation in which a timing of stopping outputting the bypass signal and a timing of stopping outputting the disconnect signal are reversed due to erroneous operation of the MCU 101 will be studied. In such a situation, the relay driver 102 attempts to stop outputting the disconnect signal before stopping outputting the bypass signal in accordance with a command from the MCU 101. In this case, since the output of the disconnect signal stops, output of the signal current to the coil CR1 of the disconnect switch S1′ stops, and output of the bypass signal also stops. Therefore, even when erroneous operation of the MCU 101 occurs, the b-contact of the disconnect switch S1′ will not be closed in a state where the a-contact of the bypass switch S2 is closed, and the electrical storage battery modules M1 to Mn are reliably prevented from being short-circuited through the bypass line BL.

The b-contact of the disconnect switch S1′ may be replaced with an a-contact, the a-contact of the disconnect switch S1′ may be replaced with a b-contact, and the a-contact of the bypass switch S2 may be replaced with a b-contact. In this case, when a corresponding one of the electrical storage battery modules M1 to Mn is connected, a signal current may be output to the coil CR1 of the disconnect switch S1′ and the coil CR2 of the bypass switch S2. When a corresponding one of the electrical storage battery modules M1 to Mn is bypassed, no signal current may be output to the coil CR1 of the disconnect switch S1′ and the coil CR2 of the bypass switch S2.

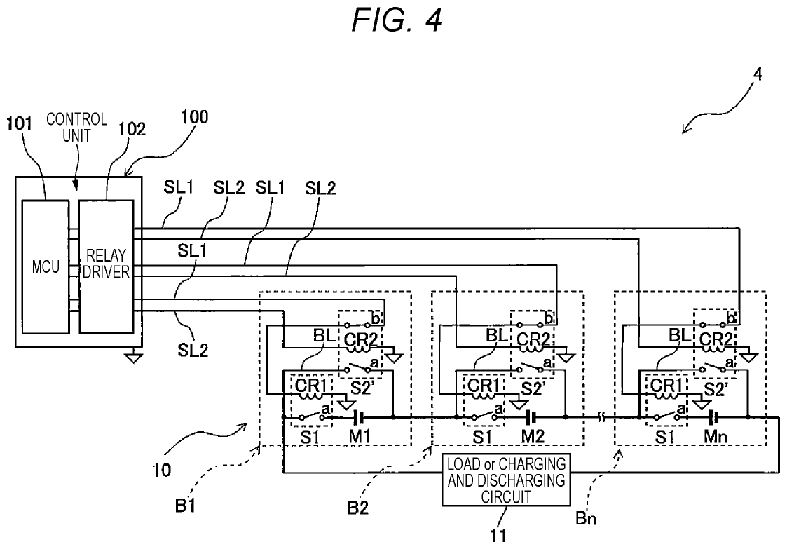

FIG. 4 is a circuit diagram schematically showing an electrical storage system 4 including the bypass circuits B1 to Bn according to another embodiment of the present disclosure. The electrical storage system 4 according to the present embodiment is different from the electrical storage system 3 according to the above-described embodiment in configurations of the bypass circuits B1 to Bn, and particularly configurations of the disconnect switches S1, S1′ and bypass switches S2′, S2.

The bypass circuits B1 to Bn according to the present embodiment each include the bypass line BL, the disconnect signal line SL1, the bypass signal line SL2, the disconnect switch S1, and the bypass switch S2′. The bypass line BL has the same configuration as that of the electrical storage system 3 according to the above-described embodiment.

n disconnect switches S1 are provided respectively for the electrical storage battery modules M1 to Mn. Examples of the disconnect switch S1 include a relay and a semiconductor switch. The disconnect switch S1 according to the present embodiment is a relay, and includes an a-contact and the coil CR1.

The a-contact of the disconnect switch S1 is provided on an electrical power line of the electrical storage battery string 10, and the coil CR1 of the disconnect switch S1 is provided in the disconnect signal line SL1. When a signal current is output from the relay driver 102 to the coil CR1 of the disconnect switch S1 through the disconnect signal line SL1, the a-contact of the disconnect switch S1 is closed, and a corresponding one of the electrical storage battery modules M1 to Mn is in a connected state.

n bypass switches S2′ are provided respectively for the electrical storage battery modules M1 to Mn. Examples of the bypass switch S2′ include a relay and a semiconductor switch. The bypass switch S2′ according to the present embodiment is a relay, and includes an a-contact, a b-contact, and the coil CR2.

The a-contact of the bypass switch S2′ is provided on the bypass line BL, and the b-contact of the bypass switch S2′ is provided on the disconnect signal line SL1. The coil CR2 of the bypass switch S2′ is provided in the bypass signal line SL2. When a signal current is output from the relay driver 102 to the coil CR2 of the bypass switch S2′ through the bypass signal line SL2, the b-contact of the bypass switch S2′ is opened, the disconnect signal line SL1 is in a disconnected state, and no signal current can be output from the relay driver 102 to the coil CR1 of the disconnect switch S1. On the other hand, when no signal current is supplied from the relay driver 102 to the coil CR2 of the bypass switch S2′, the b-contact of the bypass switch S2′ is in a closed state, and a signal current can be output from the relay driver 102 to the coil CR1 of the disconnect switch S1.

That is, during a period in which a signal current is output from the relay driver 102 to the coil CR2 of the bypass switch S2′, the disconnect signal line SL1 is disconnected by the b-contact of the bypass switch S2′, and a state in which no signal current can be output from the relay driver 102 to the coil CR1 of the disconnect switch S1 is maintained. During a period in which no signal current is supplied from the relay driver 102 to the coil CR2 of the bypass switch S2′, the disconnect signal line SL1 is connected by the b-contact of the bypass switch S2′, and a state in which a signal current can be output from the relay driver 102 to the coil CR1 of the disconnect switch S1 is maintained.

During bypass operation by the bypass circuits B1 to Bn, the relay driver 102 first stops supplying a signal current to the coil CR1 of the disconnect switch S1, and then supplies a signal current to the coil CR2 of the bypass switch S2′. That is, the relay driver 102 first switches the disconnect switch S1 to a disconnected state, and then switches the bypass switch S2′ to a connected state. Accordingly, the electrical storage battery modules M1 to Mn are prevented from being short-circuited through the bypass line BL during the bypass operation.

Here, a situation in which a timing of stopping outputting the disconnect signal and a timing of starting outputting the bypass signal are reversed due to erroneous operation of the MCU 101 will be studied. In such a situation, the relay driver 102 attempts to start outputting the bypass signal before stopping outputting the disconnect signal in accordance with a command from the MCU 101. However, at the timing of starting outputting the bypass signal, the output of the disconnect signal stops since the disconnect signal line SL1 is disconnected by the b-contact of the bypass switch S2′. Therefore, even when erroneous operation of the MCU 101 occurs, the a-contact of the bypass switch S2′ will not be closed in a state where the a-contact of the disconnect switch S1 is closed, and the electrical storage battery modules M1 to Mn are reliably prevented from being short-circuited through the bypass line BL.

On the other hand, during bypass release operation by the bypass circuits B1 to Bn, the relay driver 102 first stops outputting a signal current to the coil CR2 of the bypass switch S2′, and then starts outputting a signal current to the coil CR1 of the disconnect switch S1. That is, the control unit 100 first switches the bypass switch S2′ to the disconnected state, and then switches the disconnect switch S1 to the connected state. Accordingly, the electrical storage battery modules M1 to Mn are prevented from being short-circuited through the bypass line BL during the bypass release operation.

Here, a situation in which a timing of stopping outputting the bypass signal and a timing of starting outputting the disconnect signal are reversed due to erroneous operation of the MCU 101 will be studied. In such a situation, the relay driver 102 attempts to start outputting the disconnect signal before stopping outputting the bypass signal in accordance with a command from the MCU 101. In this case, since the bypass signal is output, the b-contact of the bypass switch S2′ is in an opened state, and no disconnect signal can be output from the relay driver 102 to the disconnect switch S1. Therefore, even when erroneous operation of the MCU 101 occurs, the a-contact of the disconnect switch S1 will not be closed in a state where the a-contact of the bypass switch S2′ is closed, and the electrical storage battery modules M1 to Mn are reliably prevented from being short-circuited through the bypass line BL.

The a-contact of the disconnect switch S1 may be replaced with a b-contact, the a-contact of the bypass switch S2′ may be replaced with a b-contact, and the b-contact of the bypass switch S2′ may be replaced with an a-contact. In this case, when a corresponding one of the electrical storage battery modules M1 to Mn is connected, no signal current may be output to the coil CR1 of the disconnect switch S1, and a signal current may be output to the coil CR2 of the bypass switch S2′. When a corresponding one of the electrical storage battery modules M1 to Mn is bypassed, a signal current may be output to the coil CR1 of the disconnect switch S1, and no signal current may be output to the coil CR2 of the bypass switch S2′.

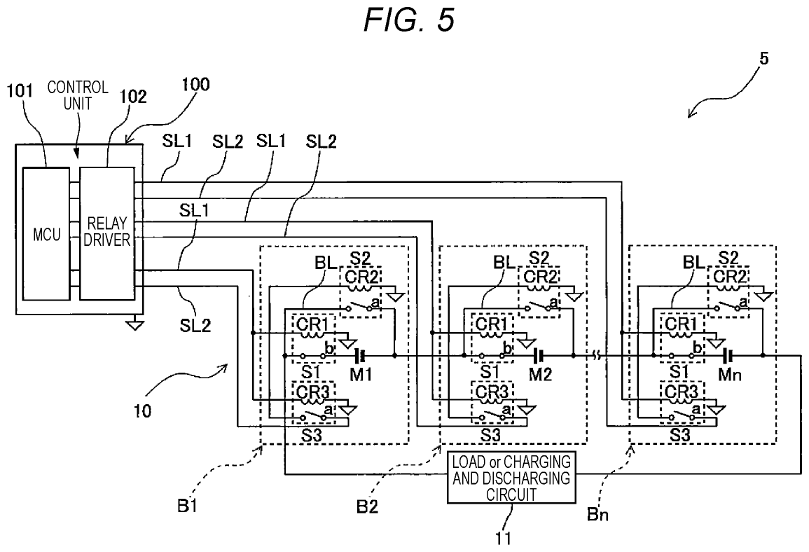

FIG. 5 is a circuit diagram schematically showing an electrical storage system 5 including the bypass circuits B1 to Bn according to another embodiment of the present disclosure. The electrical storage system 5 according to the present embodiment is different from the electrical storage system 1 according to the above-described embodiment in configurations of the bypass circuits B1 to Bn. In particular, the electrical storage system 5 according to the present embodiment is different from the electrical storage system 1 according to the above-described embodiment in that the safety switch S3 in the electrical storage system 5 is provided on the electrical storage battery string 10 side, whereas the safety switch S3 in the electrical storage system 1 is provided on the control unit 100 side.

On the other hand, the electrical storage system 5 according to the present embodiment has configurations and functions common to those of the electrical storage system 1 according to the above-described embodiment, except that the safety switch S3 is provided whether on the electrical storage battery string 10 side or on the control unit 100 side.

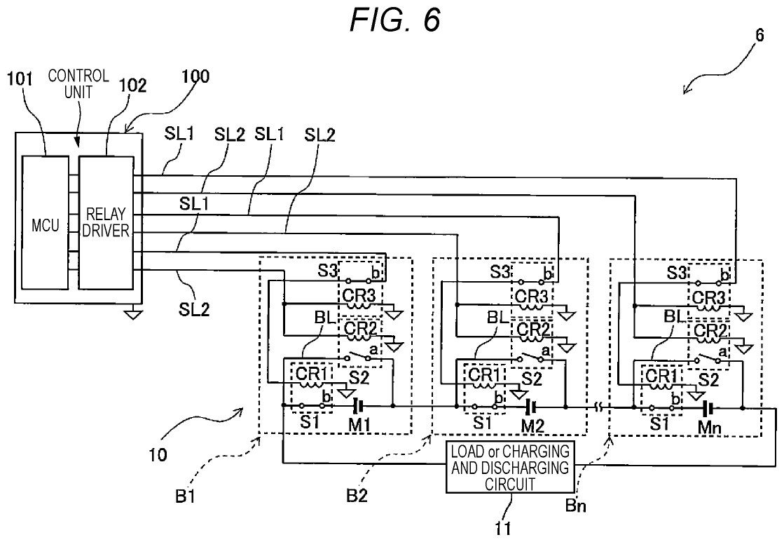

FIG. 6 is a circuit diagram schematically showing an electrical storage system 6 including the bypass circuits B1 to Bn according to another embodiment of the present disclosure. The electrical storage system 6 according to the present embodiment is different from the electrical storage system 2 according to the above-described embodiment in configurations of the bypass circuits B1 to Bn. In particular, the electrical storage system 6 according to the present embodiment is different from the electrical storage system 2 according to the above-described embodiment in that the safety switch S3 in the electrical storage system 6 is provided on the electrical storage battery string 10 side, whereas the safety switch S3 in the electrical storage system 2 is provided on the control unit 100 side.

On the other hand, the electrical storage system 6 according to the present embodiment has configurations and functions common to those of the electrical storage system 2 according to the above-described embodiment, except that the safety switch S3 is provided whether on the electrical storage battery string 10 side or on the control unit 100 side.

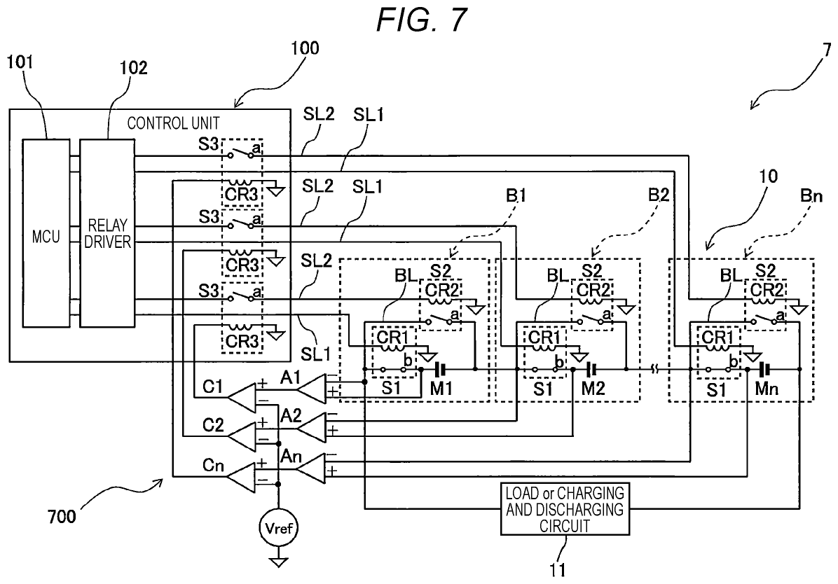

FIG. 7 is a circuit diagram schematically showing an electrical storage system 7 including the bypass circuits B1 to Bn according to another embodiment of the present disclosure. The electrical storage system 7 according to the present embodiment is different from the electrical storage system 1 according to the above-described embodiment in an operation principle of the safety switch S3.

The safety switches S3 are provided respectively for the electrical storage battery modules M1 to Mn. Examples of the safety switch S3 include a relay and a semiconductor switch. The safety switch S3 according to the present embodiment is a relay, and includes an a-contact, the coil CR3, and a detection circuit 700.

The a-contact of the safety switch S3 is provided on the bypass signal line SL2, and the coil CR3 of the safety switch S3 is connected to the detection circuit 700. The detection circuit 700 detects an opened state of the b-contact of the disconnect switch S1, and outputs a signal current to the coil CR3 of the safety switch S3. When the signal current is output from the detection circuit 700 to the coil CR3 of the safety switch S3, the a-contact of the safety switch S3 is closed, the bypass signal line SL2 is in a connected state, and the signal current can be output from the relay driver 102 to the coil CR2 of the bypass switch S2. On the other hand, when no signal current is output from the detection circuit 700 to the coil CR3 of the safety switch S3, the a-contact of the safety switch S3 is opened, the bypass signal line SL2 is in a disconnected state, and no signal current can be output from the relay driver 102 to the coil CR2 of the bypass switch S2.

That is, during a period in which no signal current is output from the detection circuit 700 to the coil CR3 of the safety switch S3, the bypass signal line SL2 is disconnected by the safety switch S3, and a state in which no signal current can be output from the relay driver 102 to the coil CR2 of the bypass switch S2 is maintained. During a period in which a signal current is output from the detection circuit 700 to the coil CR3 of the safety switch S3, the bypass signal line SL2 is connected by the safety switch S3, and a state in which the signal current can be output from the relay driver 102 to the coil CR2 of the bypass switch S2 is maintained.

An example of a configuration of the detection circuit 700 will be described. The detection circuit 700 only needs to be able to detect whether the disconnect switch S1 is in a connected state or in a disconnected state, and the configuration therefor may be appropriately changed.

The detection circuit 700 includes operational amplifiers A1 to An and comparators C1 to Cn respectively for the electrical storage battery modules M1 to Mn. The operational amplifiers A1 to An are differential amplifier circuits. The operational amplifiers A1 to An have positive input terminals (+) connected between the disconnect switches S1 and positive electrodes of the electrical storage battery modules M1 to Mn. The operational amplifiers A1 to An have negative input terminals (−) connected between the disconnect switch S1 and the load or charging and discharging circuit 11. The operational amplifiers A1 to An have output terminals connected to positive input terminals (+) of the comparators C1 to Cn.

The operational amplifiers A1 to An amplify differences between input voltages of the positive input terminals (+) and input voltages of the negative input terminals (−), and output the amplified differences from the output terminals to the positive input terminals (+) of the comparators C1 to Cn. That is, the operational amplifiers A1 to An detect potential differences between both ends of the disconnect switches S1 and output the potential differences to the positive input terminals (+) of the comparators C1 to Cn.

The comparators C1 to Cn have output terminals connected to the coils CR3 of the safety switches S3, respectively. The comparators C1 to Cn compare output voltages Vₒᵤₜ output from the operational amplifiers A1 to An to the positive input terminals (+) and a reference voltage V_{ref} input to negative input terminals (−). The comparators C1 to Cn output a signal current from the output terminals to the coils CR3 of the safety switches S3 when the output voltages Vₒᵤₜ of the operational amplifiers A1 to An are higher than the reference voltage V_{ref}.

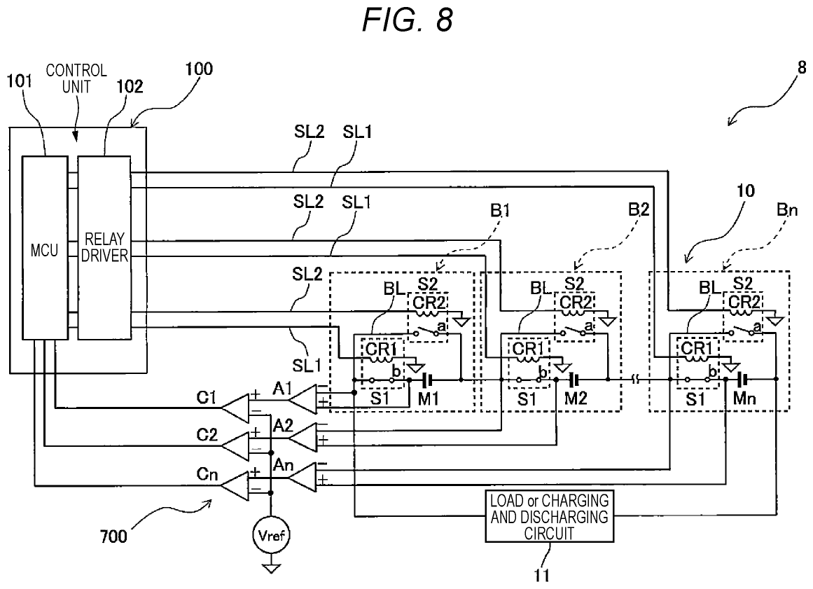

FIG. 8 is a circuit diagram schematically showing an electrical storage system 8 including the bypass circuits B1 to Bn according to another embodiment of the present disclosure. The electrical storage system 8 according to the present embodiment is different from the electrical storage system 7 according to the above-described embodiment in presence and absence of the safety switch S3.

In the electrical storage system 8 according to the present embodiment, the detection circuit 700 detects an opened state of the b-contact of the disconnect switch S1 and outputs a signal current to the MCU 101. When the signal current is output from the detection circuit 700 to the MCU 101, the MCU 101 permits the relay driver 102 to output the signal current to the coil CR2 of the bypass switch S2. On the other hand, when no signal current is output from the detection circuit 700 to the MCU 101, the MCU 101 prohibits output of the signal current from the relay driver 102 to the coil CR2 of the bypass switch S2.

That is, during a period in which no signal current is output from the detection circuit 700 to the MCU 101, a state in which no signal current can be output from the relay driver 102 to the coil CR2 of the bypass switch S2 is maintained. During a period in which a signal current is output from the detection circuit 700 to the MCU 101, a state in which the signal current can be output from the relay driver 102 to the coil CR2 of the bypass switch S2 is maintained.

Although the present disclosure is described above based on the above-described embodiments, the present disclosure is not limited to the embodiments, modifications may be made without departing from the gist of the present disclosure, and publicly known or well-known techniques may be appropriately combined.

For example, in the above-described embodiments, a relay is used as the disconnect switch S1, the bypass switch S2, and the safety switch S3. A relay delays time from energization of a coil to opening and closing of an a-contact. For example, in the electrical storage system 1 (see FIG. 1) according to the above-described embodiment, there is a delay in time from the start of outputting the disconnect signal to the closing of the a-contact of the safety switch S3. The delay in time is a delay in time from the start of outputting the disconnect signal until the bypass signal can be output, and the switching of the bypass line BL to the connected state is delayed relative to the switching of the electrical storage battery modules M1 to Mn to the disconnected state.

However, it is not necessary for the disconnect switch S1, the bypass switch S2, and the safety switch S3 to be relays, and a semiconductor switch such as a metal-oxide-semiconductor field-effect transistor (MOSFET) may be used. In this case, a delay element such as a CR filter is preferably added to a gate drive circuit to achieve the same function as that of the relay.

Here, features of the embodiment of the bypass circuit and the electrical storage system according to the present disclosure described above will be briefly summarized and listed in the following first to tenth aspects.

According to a first illustrative aspect of the present disclosure, a bypass circuit (B1 to Bn) is provided in an electrical storage system (1 to 8) including a plurality of electrical storage batteries (M1 to Mn) connected in series and bypasses the electrical storage batteries (M1 to Mn). The bypass circuit (B1 to Bn) includes: a first switch (S1, S1′) provided between the adjacent electrical storage batteries, the first switch (S1, S1′) being opened and closed in response to a first control signal output from a control circuit (102); a bypass line (BL) that bypasses the first switch and each of the electrical storage batteries; a second switch (S2, S2′) provided on the bypass line, the second switch (S2, S2′) being opened and closed in response to a second control signal output from the control circuit (102); and a co-closing prevention unit (S1′, S2′, S3) configured to prevent the first switch and the second switch from being in a closed state at the same time.

According to a second illustrative aspect of the present disclosure, the bypass circuit (B1 to Bn) may further include: a first signal line (SL1) configured to transmit the first control signal output from the control circuit (102) to the first switch (S1, S1′); and a second signal line (SL2) configured to transmit the second control signal output from the control circuit (102) to the second switch (S2, S2′). The co-closing prevention unit (S1′, S2′, S3) may include a third switch (S1′, S2′, S3) configured to prevent the first switch and the second switch from being in a closed state at the same time. The third switch (S1′, S2′, S3) may include: a first contact (a, b) provided on the second signal line (SL2); and a drive unit (CR1, CR2, CR3) operated in response to the first control signal to open and close the first contact, and the first contact (a, b) is opened to disconnect the second signal line when the first switch (S1, S1′) is in a closed state.

According to a third illustrative aspect of the present disclosure, the third switch (S1′, S2′, S3) may be provided in a control unit (100) including the control circuit (102).

According to a fourth illustrative aspect of the present disclosure, the first switch (S1, S1′) may include a second contact (a, b) provided on an electrical power line (BL) connecting the adjacent electrical storage batteries. The drive unit (CR1, CR2, CR3) may be operated in response to the first control signal to open and close the first contact and the second contact. The first contact may be opened to disconnect the second signal line when the second contact is in a closed state.

According to a fifth illustrative aspect of the present disclosure, the bypass circuit (B1 to Bn) may further include: a first signal line (SL1) configured to transmit the first control signal output from the control circuit (102) to the first switch; and a second signal line (SL2) configured to transmit the second control signal output from the control circuit to the second switch. The co-closing prevention unit (S1′, S2′, S3) may include a third switch (S1′, S2′, S3) configured to prevent the first switch and the second switch from being in a closed state at the same time. The third switch (S1′, S2′, S3) may include: a first contact (a, b) provided on the first signal line; and a drive unit operated in response to the second control signal to open and close the first contact. The first contact (a, b) may be opened to disconnect the first signal line when the second switch is in a closed state.

According to a sixth illustrative aspect of the present disclosure, the third switch (S1′, S2′, S3) may be provided in a control unit (100) including the control circuit (102).

According to a seventh illustrative aspect of the present disclosure, the second switch (S2, S2′) may include a second contact (a, b) provided on the bypass line (BL). The drive unit (CR1, CR2, CR3) may be operated in response to the second control signal to open and close the first contact and the second contact. The first contact (a, b) may be opened to disconnect the first signal line when the second contact is in a closed state.

According to an eighth illustrative aspect of the present disclosure, the bypass circuit (B1 to Bn) may further include: a first signal line (SL1) configured to transmit the first control signal output from the control circuit to the first switch; and a second signal line (SL2) configured to transmit the second control signal output from the control circuit to the second switch. The co-closing prevention unit (S1′, S2′, S3) may include a third switch (S1′, S2′, S3) configured to prevent the first switch and the second switch from being in a closed state at the same time. The third switch (S1′, S2′, S3) may include: a first contact (a, b) provided on the second signal line; a detection unit (700) configured to detect that the first switch is in an opened state; and a drive unit (CR1, CR2, CR3) configured to operate in response to a detection signal of the detection unit to open and close the first contact. The first contact (a, b) may be opened to disconnect the second signal line when the detection unit does not detect the opened state of the first switch, and be closed to connect the second signal line when the detection unit detects the opened state of the first switch.

According to a ninth illustrative aspect of the present disclosure, the bypass circuit (B1 to Bn) may further include: a first signal line (SL1) configured to transmit the first control signal output from the control circuit to the first switch; and a second signal line (SL2) configured to transmit the second control signal output from the control circuit to the second switch. The co-closing prevention unit (S1′, S2′, S3) may include: a detection unit (700) configured to detect that the first switch is in an opened state; and an output control unit (101) configured to determine whether the second control signal is output in response to a detection signal of the detection unit. The second control signal may be not output when the detection unit does not detect the opened state of the first switch, and be output when the detection unit detects the opened state of the first switch.

According to a tenth illustrative aspect of the present disclosure, an electrical storage system (1 to 8) includes: a plurality of electrical storage batteries (M1 to Mn) connected in series; and a bypass circuit (B1 to Bn) configured to bypass the electrical storage batteries (M1 to Mn). The bypass circuit (B1 to Bn) includes: a first switch (S1, S1′) provided between the adjacent electrical storage batteries, the first switch (S1, S1′) being opened and closed in response to a first control signal output from a control circuit; a bypass line (BL) configured to bypass the first switch and each of the electrical storage batteries; a second switch (S2, S2′) provided on the bypass line, the second switch (S2, S2′) being opened and closed in response to a second control signal output from the control circuit; and a co-closing prevention unit (S1′, S2′, S3) configured to prevent the first switch and the second switch from being in a closed state at the same time.

What is claimed is:

1. A bypass circuit that is provided in an electrical storage system including a plurality of electrical storage batteries connected in series and bypasses the electrical storage batteries, the bypass circuit comprising:
a first switch provided between the adjacent electrical storage batteries, the first switch being opened and closed in response to a first control signal output from a control circuit;
a bypass line that bypasses the first switch and each of the electrical storage batteries;
a second switch provided on the bypass line, the second switch being opened and closed in response to a second control signal output from the control circuit; and
a co-closing prevention unit configured to prevent the first switch and the second switch from being in a closed state at the same time.

2. The bypass circuit according to claim 1, further comprising:
a first signal line configured to transmit the first control signal output from the control circuit to the first switch; and
a second signal line configured to transmit the second control signal output from the control circuit to the second switch, wherein
the co-closing prevention unit includes a third switch configured to prevent the first switch and the second switch from being in a closed state at the same time,
the third switch includes:
a first contact provided on the second signal line; and
a drive unit operated in response to the first control signal to open and close the first contact, and
the first contact is opened to disconnect the second signal line when the first switch is in a closed state.

3. The bypass circuit according to claim 2, wherein the third switch is provided in a control unit including the control circuit.

4. The bypass circuit according to claim 2, wherein
the first switch includes a second contact provided on an electrical power line connecting the adjacent electrical storage batteries,
the drive unit is operated in response to the first control signal to open and close the first contact and the second contact, and
the first contact is opened to disconnect the second signal line when the second contact is in a closed state.

5. The bypass circuit according to claim 1, further comprising:
a first signal line configured to transmit the first control signal output from the control circuit to the first switch; and
a second signal line configured to transmit the second control signal output from the control circuit to the second switch, wherein
the co-closing prevention unit includes a third switch configured to prevent the first switch and the second switch from being in a closed state at the same time,
the third switch includes:
a first contact provided on the first signal line; and
a drive unit operated in response to the second control signal to open and close the first contact, and
the first contact is opened to disconnect the first signal line when the second switch is in a closed state.

6. The bypass circuit according to claim 5, wherein the third switch is provided in a control unit including the control circuit.

7. The bypass circuit according to claim 5, wherein
the second switch includes a second contact provided on the bypass line,
the drive unit is operated in response to the second control signal to open and close the first contact and the second contact, and
the first contact is opened to disconnect the first signal line when the second contact is in a closed state.

8. The bypass circuit according to claim 1, further comprising:
a first signal line configured to transmit the first control signal output from the control circuit to the first switch; and
a second signal line configured to transmit the second control signal output from the control circuit to the second switch, wherein
the co-closing prevention unit includes a third switch configured to prevent the first switch and the second switch from being in a closed state at the same time,
the third switch includes:
a first contact provided on the second signal line;
a detection unit configured to detect that the first switch is in an opened state; and
a drive unit configured to operate in response to a detection signal of the detection unit to open and close the first contact, and
the first contact is opened to disconnect the second signal line when the detection unit does not detect the opened state of the first switch, and is closed to connect the second signal line when the detection unit detects the opened state of the first switch.

9. The bypass circuit according to claim 1, further comprising:
a first signal line configured to transmit the first control signal output from the control circuit to the first switch; and
a second signal line configured to transmit the second control signal output from the control circuit to the second switch, wherein
the co-closing prevention unit includes:
a detection unit configured to detect that the first switch is in an opened state; and
an output control unit configured to determine whether the second control signal is output in response to a detection signal of the detection unit; and
the second control signal is not output when the detection unit does not detect the opened state of the first switch, and is output when the detection unit detects the opened state of the first switch.

10. An electrical storage system comprising:
a plurality of electrical storage batteries connected in series; and
a bypass circuit configured to bypass the electrical storage batteries, wherein
the bypass circuit includes:
a first switch provided between the adjacent electrical storage batteries, the first switch being opened and closed in response to a first control signal output from a control circuit;
a bypass line configured to bypass the first switch and each of the electrical storage batteries;
a second switch provided on the bypass line, the second switch being opened and closed in response to a second control signal output from the control circuit; and
a co-closing prevention unit configured to prevent the first switch and the second switch from being in a closed state at the same time.
